(19) United States
(12) Patent Application Publication
(10) Pub. No.: US 2006/0262708 A1
(43) Pub. Date: Nov. 23, 2006

(54) Optical head unit and optical disc apparatus

(76) Inventors: Kazuo Watabe, Yokohama-shi (JP); Sumitaka Maruyama, Yokohama-shi (JP); Hideaki Okano, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/434,870

(22) Filed: May 17, 2006

(30) Foreign Application Priority Data
May 18, 2005 (JP) 2005-145602

(51) Int. Cl. G11B 7/135

(52) U.S. Cl. 369/112.01

(57) ABSTRACT

An optical head unit according to an embodiment of the invention includes a diffraction element which has a diffraction pattern capable of outputting a non-diffraction component, ±1^{st} diffraction components, and an electric signal corresponding to the non-diffraction component, to the light-receiving surface of a photodetector which receives a reflected laser beam reflected on a recording layer of an optical disc and outputs a corresponding signal, as an signal at least for reproducing information recorded on the optical disc, and capable of outputting electric signals corresponding to the ±1^{st} diffraction components for generating a focus error signal by a spot size method. The ratio of a component output as a non-diffraction component is increased to higher than the ratio of components output as ±1^{st} diffraction components, and the signal to noise ratio of a reproduces signal is improved.

### CROSS-REFERENCE TO RELATED APPLICATIONS

This application is based upon and claims the benefit of priority from Japanese Patent Application No. 2005-145602, filed May 18, 2005, the entire contents of which are incorporated herein by reference.

### BACKGROUND

1. Field

One embodiment of the invention relates to an information recording/reproducing apparatus (optical disc apparatus) for recording, reproducing and erasing information on/from a recordable, reproduceable and erasable optical disc by using a laser beam, and an optical head unit used in the optical disc apparatus.

2. Description of the Related Art

An optical disc is widely used as a recording

medium suitable for recording, reproducing and erasing (recording repeatedly) information. Various optical discs of different standards have been proposed and are actually used. By the recording capacity, these optical discs are classified into CD and DVD. By use (data-recording systems), the discs are sorted into a read-only type containing prerecorded information (ROM), a write once type capable of recording information only once (-R), and a rewritable type (recordable/reproduceable or rewritable type) capable of recording and erasing information repeatedly (RAM or RW).

As the standard and purpose of an optical disc have been diversified, an optical disc recording/reproducing apparatus is required to be capable of recording information on an optical disc of two or more standards, reproducing prerecorded information, and erasing recorded information. In addition, it is demanded as an essential condition of an optical disc recording/reproducing apparatus to be capable of detecting a standard of an optical disc set in the apparatus, even if it is difficult to record and erase information.

Therefore, an optical pickup (optical head unit) is required at least to be capable of capturing a reflected light from tracks or a string of record marks peculiar to an optical disc and controlling the tracks and focus of an object lens (optical head unit), regardless of the standards (types) of an optical disc.

For example, Japanese Patent Application Publication (KOKAI) No. 2002-230800 proposes a system of obtaining a focus error signal by using a spot size method, in an optical pickup head system using a hologram element applicable to a two-wavelength light source usable for optical discs of CD and DVD standards.

However, in the system of the above Publication, there is a large loss caused by deviation from an ideal form of a grating pattern of a diffraction element, and it is difficult to increase the light use efficiency. Further, the loss decreases signal to noise ratio (SNR). It is limited in the characteristic and cost to increase the diffraction efficiency of a diffraction element.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an optical disc apparatus including an optical head (PUH) in accordance with an embodiment of the invention;

FIG. 2 is an exemplary diagram showing an example of a diffraction pattern of a diffraction element incorporated in an optical head of the optical disc apparatus shown in FIG. 1;

FIGS. 3A and 3B are exemplary diagrams each showing a condensing state in a photodetector by using the diffraction element with the diffraction pattern shown in FIG. 2;

FIG. 4 is an exemplary diagram showing the relationship (condensing state) between the photodetector and diffraction element of the optical head unit shown in FIG. 1;

FIGS. 5A to 5C are exemplary diagrams each showing the principle of obtaining a focus error signal (FES) by the photodetector shown in FIG. 4;

FIG. 6 is an exemplary diagram showing another example of arrangement of light-receiving areas usable in the photodetector of the optical head unit shown in FIG. 1;

FIG. 7 is an exemplary diagram showing an example of a diffraction pattern capable of using CPP (Compensation Push Pull) system, in the optical head unit including the diffraction element having the diffraction pattern explained in FIG. 4 and FIG. 5; and

FIG. 8 is an exemplary diagram showing the relationship (condensing state) between the diffraction element shown in FIG. 7 and photodetector of FIG. 1.

### DETAILED DESCRIPTION

Various embodiments according to the invention will be described hereinafter with reference to the accompanying drawings. In general, according to one embodiment of the invention, an optical head unit according to an embodiment of the invention includes a diffraction element which has a diffraction pattern capable of outputting a non-diffraction component, ±1^{st} diffraction components, and an electric signal corresponding to the non-diffraction component, to the light-receiving surface of a photodetector which receives a reflected laser beam reflected on a recording layer of an optical disc and outputs a corresponding signal, as an signal at least for reproducing information recorded on the optical disc, and capable of outputting electric signals corresponding to the ±1^{st} diffraction components for controlling the focus of the object lens by a spot size method.

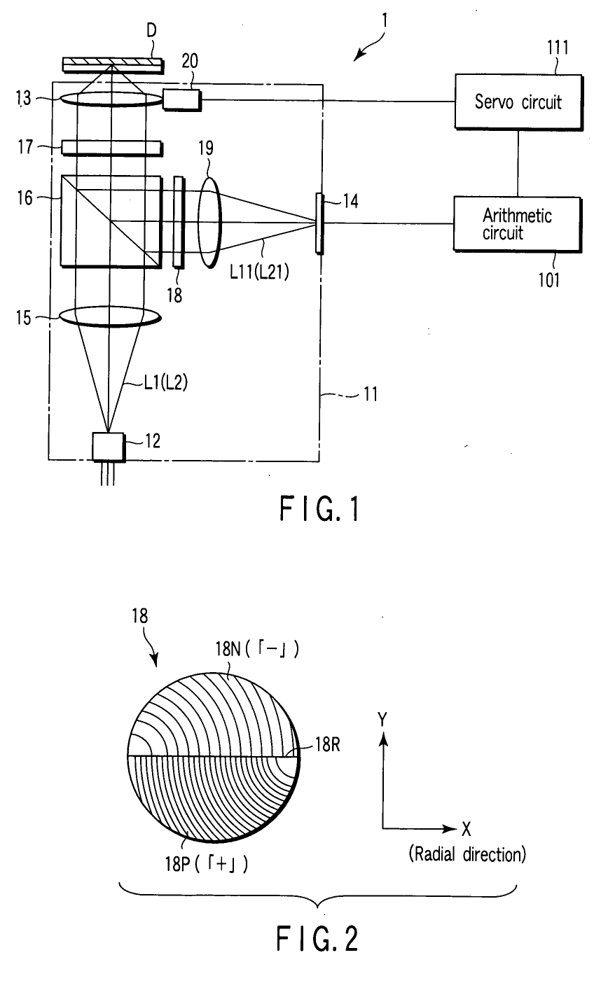

According to an embodiment, FIG. 1 shows an example of an optical disc apparatus or an information recording/reproducing apparatus according to an embodiment of the present invention.

An information recording/reproducing apparatus or an optical disc apparatus 1 shown in FIG. 1 can record or reproduce information on/from an optical disc D by condensing a laser beam emitted from an optical pickup head (PUH), hereinafter called an optical head unit) 11, on the information-recording layer of the optical disc D, or a recording medium.

The optical disc D is held on a not-shown turntable of a not-shown disc motor (to rotate the turntable), and rotated at a fixed speed by the rotation of the disc motor at a fixed speed.

The PUH (optical head unit) 11 is moved by a not-shown pickup sending motor in the radial direction of the optical disc D at a predetermined speed, when recording, reproducing or erasing information.

As explained later, the optical head unit (PUH) 11 is provided with a light source 12 which emits light L1 or L2 with different first and second wavelengths, an object lens 13 which condenses the light L1 or L2 emitted from the light source 12 on the recording surface of the optical disc D, and captures a reflected light L11 or L21 reflected on the recording surface of the optical disc D, and a photodetector (PD) 14 which receives the reflected light L11 or L21 from the optical disc D captured by the object lens 13, and outputs a current corresponding to the intensity of the light.

The light source 12 is a two wavelength semiconductor laser element composed of a first semiconductor laser chip which emits an optical beam (laser beam) L1 with a purple wavelength band in a range of 400 to 410 nm (typically, 405 nm), and a second semiconductor laser chip which emits an optical beam (laser beam) L2 with a red wavelength band in a range of 645 to 660 nm (typically, 650 nm), which are contained in the same package.

The laser beam L1 or L2 emitted from the semiconductor laser element 12 is collimated and paralleled by a collimator lens 15, and transmitted through a polarization beam splitter 16 and λ/4 plate 17, and guided to the object lens 13. The numerical aperture (NA) of the object lens 13 is 0.65, for example.

The laser beam L1 or L2 guided to the object lens 13 is given a predetermined convergence by the object lens 13, and condensed on the information recording layer formed to a predetermined depth from the substrate surface (light incident surface) of the optical disc D.

The reflected laser beam L11 or L21 reflected on the information recording layer of the optical disc D is transmitted through the substrate of the optical disc D, captured by the object lens 13, and made parallel.

The reflected laser beam L11 or L21 paralleled by the object lens 13 is transmitted through the λ/4 plate 17, and returned to the polarization beam splitter 16.

The reflected laser beam L11 or L21 returned to the polarization beam splitter 16 is reflected by the polarization beam splitter 16, because the polarizing direction is rotated by 90° with respect to the polarizing direction by the two times of transmission through the λ/4 plate 17. The λ/4 plate 17 uses an element with a wide band showing sufficient characteristic to the first and second wavelengths.

The reflected laser beam L11 or L21 reflected by the polarization beam splitter 16 is divided into a predetermined number of pieces (areas) and given a predetermined directivity when passing though the diffraction element 18, and applied to a condenser lens 19. The diffraction element 18 may be provided at any position between the object lens 13 and condenser send 19 on the reflection optical path. If the diffraction element is provided on the incident optical path, a polarization diffraction element should be used to diffract only a reflected luminous flux.

The reflected laser beam of optical direction and number applied to the condenser lens 19 is given a predetermined convergence by the condenser lens 19, and condensed to a detection cell corresponding to the photodetector 14 including light-receiving areas (detection cells).

A current (photoelectric conversion current) is output corresponding to the intensity of the light applied to each detection cell of the photodetector 14. The current is converted to a voltage signal by a not-shown I/V amplifier, and applied to an arithmetic circuit (signal processor) 101.

The voltage signal applied to the arithmetic circuit 101 is used by the arithmetic circuit for the calculation to generate (output) an HF signal (information reproduce signal), a focus error signal to indicate displacement of the distance between the distance from the object lens 13 to the optical disc D and the focal distance specific to the object lens 13, and a track error signal to indicate displacement of a condensing center of a laser beam condensed by the object lens 13 from the track (guide groove) specific to the optical disc D or the center of a string of record marks.

A part of the signal output from the arithmetic circuit 101 is supplied to a servo circuit (object lens position control circuit) 111 to position the object lens 13 to a on-focus state for the recording layer of the optical disc D (at the position where the focus error is “zero”), and to a on-track state for the track (guide groove) or string of recording marks of the recording layer of the optical disc D (at the position where the track error is “zero”).

The object lens 13 is held by an actuator 20 which moves the object lens 13 in an optical direction, movably in the vertical (focus) direction, disc radial (track) direction and tilt direction (radial or/and tangential direction).

Therefore, when the servo circuit 11 supplies the actuator 20 with an error servo signal corresponding to the focus error signal to position the object lens 13 to the focused state, an optical spot of the laser beam condensed by the object lens 13 is condensed on the recording layer of the optical disc D in a predetermined spot size. The servo circuit 111 also supplies the actuator 20 with a servo signal corresponding to the track error signal, so that the center of the optical spot coincides with the center of the track or string of record marks on the recording layer of the optical disc D through the object lens 13, and the optical spot coincides with the center of the tracks or string of record marks.

FIG. 2 shows an example of the characteristic of a plane of a diffraction element.

The diffraction element 18 is defined parallel to the radial direction (X direction) of the recording surface of the optical disc D, and divided into a first diffraction area 18N and a second diffraction area 18P by a division line 18R to divide the diffraction element at substantially the center.

Each of the diffraction areas 18N and 18P is formed with a pattern to generate a diffraction lens effect (a pattern with a pitch of a diffraction pattern changed along the division line 18R). In the example shown in FIG. 2, the pitch of the second diffraction area 18P is defined narrower than the pitch of the first area 18N, and given a stronger power. The polarity of the power of each area is defined reversely. Namely, the power of the first area 18N is negative (diffraction to make the sign of a diffraction light “−”, that is, acting in the direction to increase the power of the condenser lens 19), and the power of the second area 18P is positive (diffraction to make the sign of a diffraction light “+”, that is, acting in the direction to increase the power of the condenser lens 19).

Namely, the first area 18N generates only a −1^{st} diffraction light, and the second area 18P generates only a +1^{st} diffraction light. Therefore, when the condenser lens 19 condenses optional reflected laser beams L11 and L21 on the light-receiving surface of the photodetector 14, the degree of condensation is reduced in the area 18N and increased in the area 18P.

The diffraction element 18 also generates a non-diffraction light (0^{th} light substantially passing through the diffraction element 18), in addition to a diffraction light (±1^{st} diffraction light). The ratio of the 0^{th} light to +1^{st} diffraction light (or −1^{st} diffraction light) is defined to 10:1, for example.

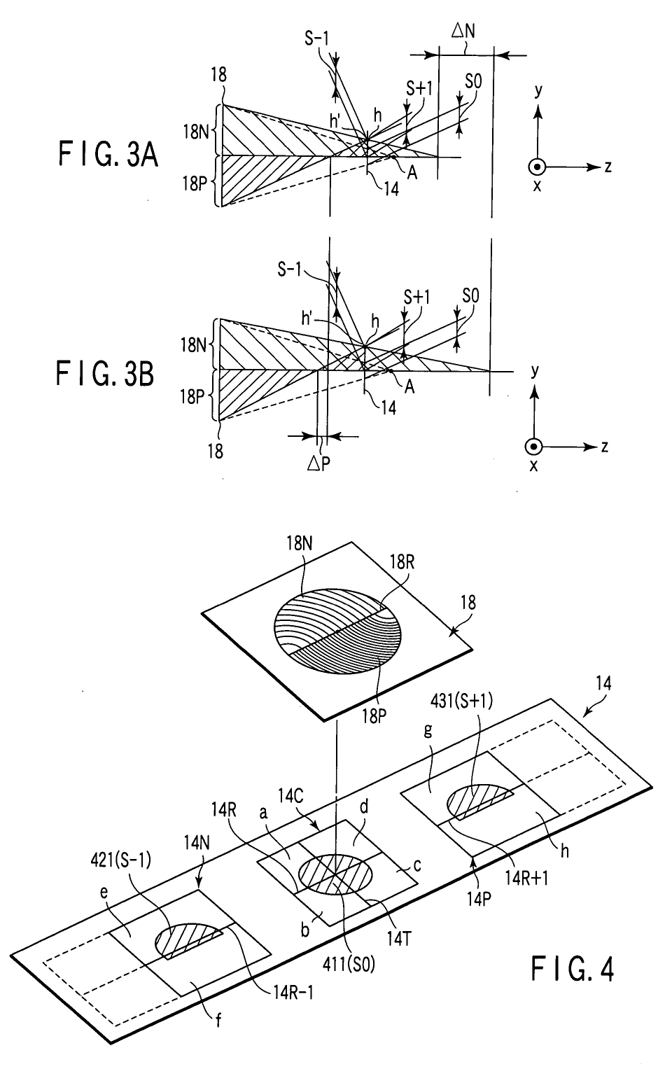

FIGS. 3A and 3B show states that an optical beam (luminous flux) emitted from a condenser lens is condensed in a photodetector. In FIGS. 3A and 3B, the Z-axis represents an optical axis direction, X-axis represents a radial direction of the optical disc D, and Y-axis represents a tangential direction of a circumference of the optical disc D. An example of an optical beam with a wavelength of 405 nm will be explained below by using FIG. 3A, and an example of an optical beam with a wavelength of 650 nm will be given by using FIG. 3B.

As seen from FIG. 3A, when a wavelength of a laser beam (optical beam) is 405 nm, a 0^{th} light S0 passing through the diffraction element 18 is focused at a point A.

The photodetector 14 is positioned in front of the point (condensing point) A, and the 0^{th} light becomes an optical spot larger than an optical spot at the condensing point A, on the light-receiving surface of the photodetector 14. The photodetector 14 may be provided in the rear of the point A (in the direction of Z, passing over the point A and separating away from the grating 18).

By displacing the position of the photodetector 14 from the condensing point A, the arrangement (positioning) of a four divided photodetector for receiving a 0^{th} light becomes easy, and a differential phase detection (DPD) signal, that is, a tracking error signal, and a push-pull signal can be easily obtained with the gain higher than a predetermined value. Contrarily, if the photodetector 14 is positioned at the condensing point A, the optical spot of 0^{th} light is too small, and adjustment of the light-receiving balance of the four divided photodetector becomes difficult.

The −1^{st} diffraction light S−1 passing through the area 18N of the diffraction element 18 is focused in the rear of the condensing point A (in the Z direction, separating away from the grating 18), because the focal distance is longer than the intrinsic focal distance of the condenser lens 19. Therefore, the optical spot has a certain height h in the photodetector 14.

On the other hand, the +1^{st} diffraction light S+1 passing through the area 18P of the diffraction element 18 is focused in the front side of the condensing point A (in the Z direction, coming close to the grating 18), because the focal distance is shorter than the intrinsic focal distance of the condenser lens 19. Therefore, the optical spot has a certain height h in the photodetector 14. Therefore, the optical spot has a certain height h′ in the photodetector 14.

Therefore, by setting the power h and h′ given to the areas 18N and 18P to the same, the optical spot diameter (optical spot area) on the photodetector 14 by the areas 18N and 18P can be substantially the same.

This technique makes enables detection of a focus error by the spot size method on the photodetector 14.

Though not judged from FIG. 3A, the luminous flux (optical beam) passing through the area 18N is condensed in the “−” side of the X direction (in the rear of paper surface), and the luminous flux (optical beam) passing through the area 18P is condensed in the “+” side of the X direction (in the front of paper surface).

As seen from FIG. 3B, when the wavelength of a laser beam (optical beam) is 650 nm, the power by diffraction is increased by the wavelength longer than a laser beam with a wavelength of 405 nm (the influence of diffraction is increased).

Namely, the −1^{st} diffraction light passing through the area 18N of the diffraction element 18 is focused in the rear of the condensing point A (in the Z direction, separating away from the grating 18), because the focal distance is longer than the intrinsic focal distance of the condensing lens 19, that is, longer than the focal distance of a laser beam with a wavelength of 405 nm. Contrarily, the +1^{st} diffraction light passing through the area 18P of the diffraction element 18 is focused in front of the condensing point A (in the Z direction, coming close to the grating 18), because the focal distance is shorter than the intrinsic focal distance of the condensing lens 19, that is, longer than the focal distance of a laser beam with a wavelength of 405 nm.

In other words, when defining the difference [symbol] N of a condensing point as a system to reduce the power of the condenser lens 19 by diffraction, the distance is increased until a laser beam with a wavelength of 650 nm crosses an optical axis. when defining the difference [symbol] P of a condensing point as a system to increase the power of the condenser lens 19 by diffraction, the distance is decreased until a laser beam with a wavelength of 650 nm crosses an optical axis.

The condensing point S0 of 0^{th} light (non-diffraction light) is the same as that of a laser beam with a wavelength of 405 nm, and the light-receiving surface of the photodetector 14 can be set to the same position as that set for a laser beam with a wavelength of 405 nm.

Comparing with a laser beam with a wavelength of 405 nm, a laser beam with a wavelength of 650 nm is higher on the photodetector 14, but the ±1^{st} diffraction light of the diffraction element 18 is substantially the same size optical spot at the same position of the photodetector 14. Therefore, detection of a focus error by the spot size method is possible with the same detection system, regardless of the wavelength of a laser beam.

By positioning the photodetector 14 in front of the condensing point (in the “−” side of the Z direction) of a diffraction light of the area 18N having the negative power, and in the rear of the condensing point (in the “+” side of the Z direction) of a diffraction light of the area 18P having the positive power, the spot size method can be applied to two laser beams with different wavelengths in a common detection system. Further, as the photodetector 14 can receive the 0^{th} light (non-diffraction light) passing through the diffraction element 18, the HF signal and tracking error (PP) signal can be efficiently taken out.

FIG. 4 shows the relationship (condensing state) between the photodetector and diffraction element of the optical pickup (optical head unit) shown in FIG. 1.

In FIG. 4, elements are extracted and simplified, so that the axial line of the laser beam passing through the diffraction element 18 coincides with the center of the 0^{th} light passing through the diffraction element 18 and the center of the 0^{th} light receiving part (4-divided detector) among the light-receiving parts of the photoconductor 14.

As shown in FIG. 4, the photodetector 14 has a first (central) light-receiving part 14C to condense the 0^{th} light passing through the diffraction element 18 (indicated by S0 in FIGS. 3A and 3B), a second (weak) light-receiving part 14N to condense the −1^{st} diffraction light diffracted by the first diffraction area 18N of the diffraction element 18 (indicated by S−1 in FIGS. 3A and 3B), and a third (strong) light-receiving part 14P to condense the +1^{st} diffraction light diffracted by the second diffraction area 18P of the diffraction element 18 (indicated by S+1 in FIGS. 3A and 3B).

The first (central) light-receiving part 14C is a widely used four divided photodetector, which condenses an optical spot 411 (S0) of the 0^{th} light (non-diffraction light) passing through the diffraction element 18.

The second (weak) light-receiving part 14N and third (strong) light-receiving part 14P are widely used two divided photodetectors, which condense an optical spot 421 (S−1) of the −1^{st} diffraction light diffracted by the area 18N of the diffraction element 18 and an optical spot 431 (S+1) of the +1^{st} diffraction light diffracted by the area 18P.

The first light-receiving part 14C for detecting the 0^{th} light is divided into four portions by two division lines 14R and 14T vertical to each other. The second and third light-receiving parts 14N and 14P for detecting the −1^{st} diffraction light and +1^{st} diffraction light are divided into two portions by division lines 14R−1 and 14R+1 parallel to the radial direction of the optical disc D.

In the following description, the cells of the four divided light-receiving part 14C are called a (the second quadrant, mathematically), b (the third quadrant), c (the fourth quadrant) and d (the first quadrant), sequentially from the upper left.

The upper and lower cells of the two divided light-receiving part 14N are called e (first/second quadrants) and f (third/fourth quadrants). The upper and lower cells of the two divided photodetector 14P are called g (first/second quadrants) and h (third/fourth quadrants).

Each cell outputs a current corresponding to the intensity of a laser beam (optical beam) applied to that cell.

The output current is converted to a voltage output by a not-shown I/V conversion amplifier.

Assuming that the voltage output signals obtained from the cells a to h are Sa to Sh, the focus error signal FES by the spot size method is obtained by
FES=(Se+Sh)−(Sf+Sg) (1)

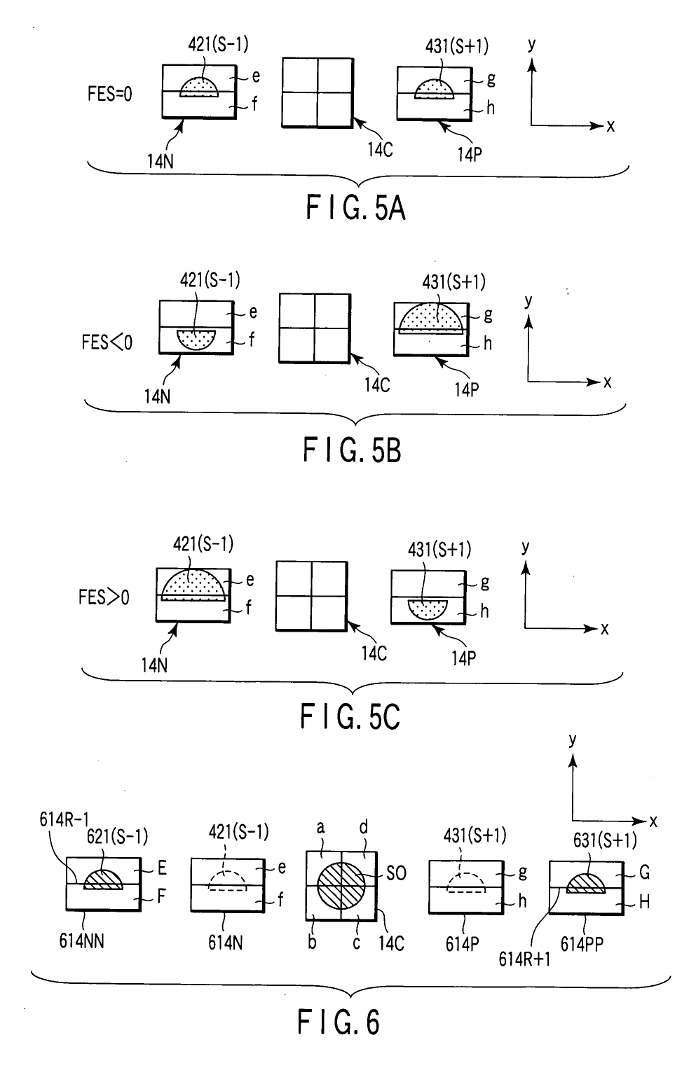

FIGS. 5A to 5C show the principle of obtaining the focus error signal (FES) by the photodetector shown in FIG. 4. FIG. 5A shows the state focused on the recording layer of the optical disc D. FIG. 5B shows the state that the object lens 13 is separated farther from the recording layer of the optical disc D compared with the on-focus state (the space between the object lens 13 and optical disc D is larger than the focal distance of the object lens 13). FIG. 5C shows the state that the object lens 13 is close to the recording layer of the optical disc D compared with the on-focus state (the space between the object lens 13 and optical disc D is smaller than the focal distance of the object lens 13).

In FIG. 5A, the FES obtained by the above equation (1) is 0. In FIG. 5B, the FES is a negative value. In FIG. 5C, the FES is a positive value. Therefore, by moving the object lens 13 in the vertical direction of FIG. 1 (the distance from the light source 12 to the optical disc D is changed) by the actuator 20 based on the focus error signal, the object lens 13 (PUH 11) can be controlled to the on-focus position on the recording layer of the optical disc D.

In the four divided light-receiving part 14C of FIG. 4, the condensing spot S0 of the 0^{th} light of the diffraction element 18 is condensed, so that the center of the spot coincides with the crossing point of the two division lines 14R and 14T.

Therefore, the tracking error signal PP by the push-pull method can be obtained from the 4-divided light-receiving part 14C by
PP=(Sa+Sb)−(Sd+Sc) (2)

The tracking error signal PP is indispensable when the optical disc D is a rewritable type having a guide groove (track) on the recording layer, or a write once type.

When the optical disc D is a read-only type and only a string of pits (record marks) is formed on the recording layer, the tracking error signal DPD by the differential phase detection (DPD) method can be obtained by
DPD=Ph(Sa+Sc)−Ph(Sb+Sd) (3)

In the equation (3), the operator of Ph (D+D, D is an output signal) detects the phase of a signal in (D+D), and expresses the operation to detect the phase difference between the signals Sa+Sc and Sb+Sd in the equation (3).

When extracting a high frequency (HF) signal to read the data recorded in the recording layer of the optical disc D, in addition to the servo signal, the HF signal can be obtained
HF=(Sa+Sb+Sc+Sd) (4)

Further, as a method of increasing the light use efficiency of the HF signal, the HF signal can also be obtained by
HF=(Sa+Sb+Sc+Sd+Se+Sf+Sg+Sh) (5)

In this case, the HF signal is generated not only from the 0^{th} light but also the +1^{st} diffraction light (and −1^{st} diffraction light) of the diffraction optical element 25, and the light use efficiency is increased. This contributes to increase the SNR.

In FIG. 4 (and FIGS. 5A to 5C), there is only one pair of light-receiving parts (14N and 14P), which receives the ±1^{st} diffraction light diffracted by the diffraction element 18.

However, considering the case of using laser beams with different wavelengths, it is easily understand that if a wavelength is 650 nm, the condensing spots S−1 and S+1 of the ±1^{st} diffraction light condensed on the photodetector 14 are moved to the side far from the central (0^{th} light) light-receiving part 14C, compared with the case that a wavelength is 405 nm.

Therefore, it is possible to detect a diffraction light of laser beams with any wavelength by enlarging the whole detectable area of the two divided light-receiving parts 14N and 14P by increasing the area as indicated by a broken line in FIG. 4.

As shown in FIG. 6, it is also possible to provide two divided light-receiving parts 614NN and 614PP (600 is added for identification) outside (or inside) the two divided light-receiving parts, for a laser beam with a wavelength of 650 nm. Each of the light-receiving parts 614NN and 614PP is divided into two portions by division lines 614R−1 and 614R+1 parallel to the radial direction of the recording layer of the optical disc D, and has cells indicated by E/F and G/H.

When the photodetector 614 (shown in FIG. 6) is used, the optical spot 421 (S−1) generated by a laser beam with a wavelength of 405 nm, that is, the −1^{st} optical spot diffracted by the area 18N of the diffraction element 18 is condensed on the light-receiving part 614N, and the optical spot 621 (S−1) generated by a laser beam with a wavelength of 650 nm, that is, the same −1^{st} optical spot is condensed on the light-receiving part 614NN. Similarly, the optical spot 431 (S+1) generated by a laser beam with a wavelength of 405 nm, that is, the −1^{st} optical spot diffracted by the area 18P of the diffraction element 18 is condensed on the light-receiving part 614P, and the optical spot 631 (S+1) generated by a laser beam with a wavelength of 650 nm is condensed on the light-receiving part 614PP.

Assuming that the voltage output signals obtained from the cells a to h and E to H are Sa to Sh and SE to SH, the focus error signal FES by the spot size method can be obtained by the above equation (1) for a laser beam with a wavelength of 405 nm, and obtained by the following equation for a laser beam with a wavelength of 650 nm
FES=(SE+SH)−(SF+SG) (1′).

As explained above, according to the optical pickup unit of the present invention, a HF signal is generated from a 0^{th} light passing through a diffraction element, and the light use efficiency of the HF signal is increased. Because, a diffraction efficiency is limited in a diffraction element, though the efficiency is increased for ±1^{st} light, and increasing a diffraction efficiency of a 0^{th} transmission light is usually useful, including a manufacturing process.

Namely, when a HF signal is generated by using only a +1^{st} light (or −1^{st} light) diffracted by a diffraction element, a loss caused by deviation from an ideal form of a diffraction element is large, and only 60% of the light use efficiency can be obtained. Therefore, the loss of 40% causes decrease of signal to noise ratio (SNR).

By designing a diffraction element optimum by using a 0^{th} light as an HF signal and setting the ratio to a +1^{st} light (or a −1^{st} light) to 10:1 as in this embodiment, the light use efficiency of 0^{light} can be easily increased to over 70%. In this case, the light use efficiency of HF signal can be increased by about 17 ((70−60)/60)%.

Therefore, by taking the form of this embodiment, the SNR of HF signal is increased, and the manufacturing margin of an optical pickup can be increased.

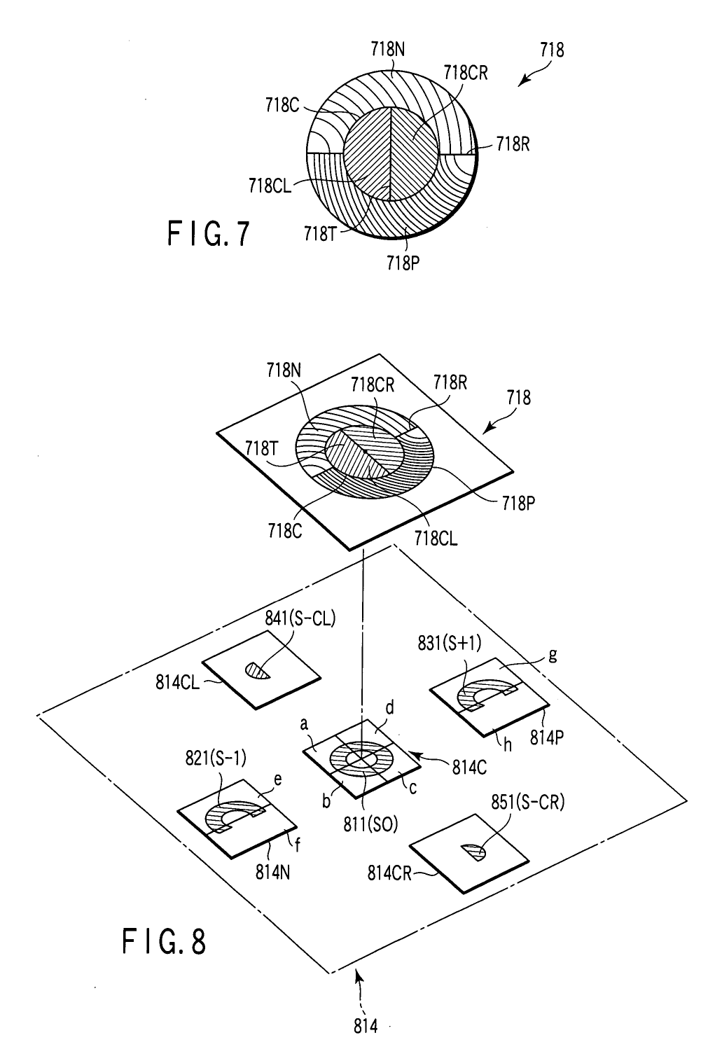

FIG. 7 shows a diffraction pattern of a diffraction element usable for a system combined with a compensation push-pull method, in the optical pickup unit already explained in FIGS. 2, 4 and FIGS. 5A to 5C.

A diffraction element 718 (700 is added for identification) shown in FIG. 7 has areas 718CL and 718CR at the center, which are divided by a circular division line 718C, and obtained by further dividing a diffraction pattern area divided in the direction orthogonal to the a division line 718R, into two portions by a division line 718T extending in the tangential direction. The areas 718N and 718P function substantially the same as in the example shown in FIGS. 2 and 4, and detailed explanation will be omitted.

The areas 718CL and 718CR have no lens effect, and simply diffract and deflect an incident luminous flux.

Each area (diffraction pattern) can generate a non-diffraction light (0^{th} light) (having a simple light transmitting capability). The ratio of the 0^{th} light to +1^{st} diffraction light (or −1^{st} diffraction light) is defined to 10:1.

FIG. 8 shows the relationship (condensing state) between the diffraction element shown in FIG. 7 and the photodetector of FIG. 1, like in FIG. 4. In FIG. 8, elements are extracted and simplified, so that the axial line of the laser beam passing through the diffraction element 718 coincides with the center of the 0^{th} light passing through the diffraction element 718 and the center of the 0^{th} light receiving part (4-divided detector) among the light-receiving parts of the photoconductor 814. (800 is added for identification).

As shown in FIG. 8, the photodetector 814 has a first (central) light-receiving part 814C to condense the 0^{th} light passing through the diffraction element 718, a second (weak) light-receiving part 814N to condense the −1^{st} diffraction light diffracted by the first diffraction area 18N of the diffraction element 718 (indicated by S−1 in FIGS. 3A and 3B), and a third (strong) light-receiving part 814P to condense the +1^{st} diffraction light diffracted by the second diffraction area 718P of the diffraction element 718. Further, the photodetector 814 has a first compensation light-receiving part 814CL and a second compensation light-receiving part 814CR.

The first light-receiving part 814C for detecting the 0^{th} light is divided into four portions by two division lines 814R and 814T vertical to each other. The second and third light-receiving parts 814N and 814P for detecting the −1^{st} diffraction light and +1^{st} diffraction light are divided into two portions by division lines 814R−1 and 814R+1 parallel to the radial direction of the optical disc D.

The cells of the 4-divided light-receiving part 814C are called a (the second quadrant, mathematically), b (the third quadrant), c (the fourth quadrant) and d (the first quadrant), sequentially from the upper left.

The upper and lower cells of the two divided light-receiving part 814N are called e (first/second quadrants) and f (third/fourth quadrants). The upper and lower cells of the two divided photodetector 814P are called g (first/second quadrants) and h (third/fourth quadrants).

The first (central) light-receiving part 814C is a known four divided photodetector, and condenses the optical spot 811 (S0) of the 0^{th} light (non-diffraction light) passing through the diffraction element 718.

The second (weak) light-receiving parts 814N and third (strong) light-receiving part 814P are known two divided photodetectors, which condense the optical spot 821 (S−1) of the −1^{st} diffraction light diffracted by the area 718N of the diffraction element 718, and the optical spot 831 (S+1) of the +1^{st} diffraction light diffracted by the area 718P.

The first and second compensation light-receiving parts 814CL and 814CR are non-divided light-receiving parts, which are orthogonal to the segment connecting the central (0^{th} light) detecting light-receiving part 814C, weak light-receiving part 814N and strong light receiving part 814P, and positioned at the distance previously defined by the compensation diffraction areas 718CL and 718CR of the diffraction element 718 (predetermined distance from the 0^{th} light receiving part 814C). The cells of the compensation light-receiving parts 814CL and 814CR are called CL and CR. These cells condense the optical spot 841 (S−CL) and 851 (S−CR).

Each cell outputs a current corresponding to the intensity of a laser beam (optical beam) applied to that cell.

The output current is converted to a voltage output by a not-shown I/V conversion amplifier.

Assuming that the voltage output signals obtained from the cells a to h, CL and CR are Sa to Sh, SCL and SCR, the focus error signal FES by the spot size method is obtained by the equation (1) as already explained.
FES=(Se+Sh)−(Sf+Sg)

On the other hand, when the optical disc D is a rewritable type having a guide groove (track) on the recording layer, or a write once type, the tracking error signal compensation push pull (CPP) is obtained by
CPP=(Sa+Sb)−(Sd+Sc)−k(SCL−SCR) (6)

Where, k is a compensation coefficient.

By selecting an appropriate value for k, a tracking error signal by the widely used compensation push-pull method can be obtained.

Of course, the compensation push-pull method has an effect to control a tracking offset generated when the object lens 13 (refer to FIG. 1) is shifted to the radial direction.

The HF signal for reading data from the recording layer of the optical disc D is obtained by
HF=(Sa+Sb+Sc+Sd+SCL+SCR) (7).

As a method of increasing the light use efficiency of HF signal, the HF signal can also be obtained by
HF=(Sa+Sb+Sc+Sd+Se+Sf+Sg+Sh+SCL+SCR) (8).

As explained hereinbefore, by using the light-receiving optical system defined by the present invention, the light use efficiency of the HF signal generated when reproducing the information recorded in an optical disc (recording medium) can be increased by using a 2-wavelength compatible optical pickup (PUH), and the signal to noise ratio (SNR) of a reproduce signal can be improved.

At the same time, a track error can be exactly detected in a system in which a lens shift is superposed on an object lens.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, in the detailed description of the invention, an optical disc apparatus is taken as an example of embodiment of the invention. The invention is of course applicable also to a video camera and a portable acoustic apparatus to contain musical data.

What is claimed is:

1. An optical head unit comprising:
a first light source which outputs light with a first wavelength;
a second light source which outputs light with a second wavelength different from the first wavelength;
an object lens which condenses the light with different wavelengths from the first and second light sources, on a recording layer of a recording medium;
a diffraction element which generates a non-diffraction component and ±1^{st} diffraction components from the lights with the different wavelengths reflected on the recording layer of the recording medium and captured by the object lens; and
a photodetector which has detection areas to independently detect the −1^{st} diffraction component, non-diffraction component and +1^{st} diffraction component generated by the diffraction element, outputs an electric signal corresponding to the non-diffraction component generated by the diffraction element at least as a signal for reproducing information recorded on the recording layer of the recording medium, and outputs electric signals corresponding to the ±1^{st} diffraction components generated by the diffraction element for generating a focus error signal.

2. The optical head unit according to claim 1, wherein the area for generating the non-diffraction component of the diffraction element is common to the area for generating the ±1^{st} diffraction components, and the component output of the non-diffraction component is higher than the component output of the ±1^{st} diffraction components.

3. The optical head unit according to claim 1, wherein the light with different wavelengths passing through the area of the diffraction element for generating the non-diffraction component is used also for generating a track error signal.

4. The optical head unit according to claim 2, wherein the light with different wavelengths passing through the area of the diffraction element for generating the non-diffraction component is used also for generating a track error signal.

5. The optical head unit according to claim 1, further comprising a compensation diffraction area which is provided in the diffraction element, and generates a diffraction component used for compensation of a push-pull signal used for a track error signal.

6. The optical head unit according to claim 2, further comprising a compensation diffraction area which is provided in the diffraction element, and generates a diffraction component used for compensation of a push-pull signal used for a track error signal.

7. The optical head unit according to claim 3, further comprising a compensation diffraction area which is provided in the diffraction element, and generates a diffraction component used for compensation of a push-pull signal used for a track error signal.

8. The optical head unit according to claim 1, wherein the electric signals corresponding to the ±1^{st} diffraction components are used by adding to the signal for reproducing information recorded on the recording layer of the recording medium.

9. The optical head unit according to claim 1, wherein the diffraction pattern for generating the ±1^{st} diffraction components of the diffraction element is divided into two areas by a dividing line lying along the radial direction of the recording medium, and has a negative lens power in one area and a positive lens power in the other area.

10. The optical head unit according to claim 9, wherein the diffraction pattern for generating the ±1^{st} diffraction components of the diffraction element is divided into two areas by a dividing line lying along the radial direction of the recording medium, and has a negative lens power in one area and a positive lens power in the other area, and generates the diffraction component for the light with different wavelengths on the same detection plane, so that the ray bundles diffracted by the two areas has substantially equal area on the detection plane.

11. The optical head unit according to claim 1, wherein the diffraction pattern for generating the ±1^{st} diffraction components of the diffraction element is divided into two areas by a dividing line lying along the radial direction of the recording medium, and has a negative lens power in one area and a positive lens power in the other area, and condenses the light with different wavelengths on the photodetector which has independent detection areas for the light with different wavelengths at positions displaced to the radial direction of the recording medium with respect to a spot position of the non-diffraction component, on the same detection surface.

12. An optical disc apparatus comprising:
an optical head unit comprising a first light source which outputs light with a first wavelength; a second light source which outputs light with a second wavelength different from the first wavelength; an object lens which condenses the light with different wavelengths from the first and second light sources, on a recording layer of a recording medium; a diffraction element which generates a non-diffraction component and ±1^{st} diffraction components from the light with different wavelengths reflected on the recording layer of the recording medium and captured by the object lens; and a photodetector which has detection areas to independently detect the −1^{st} diffraction component, non-diffraction component and +1^{st} diffraction component generated by the diffraction element, outputs an electric signal corresponding to the non-diffraction component generated by the diffraction element at least as a signal for reproducing information recorded on the recording layer of the recording medium, and outputs electric signals corresponding to the ±1^{st} diffraction components generated by the diffraction element for generating a focus error signal; and
a signal processor which reproduces information recorded in the recording medium from the photodetector corresponding to the non-diffraction component passing through the diffraction element.
